(19) United States
(12) Patent Application Publication
(10) Pub. No.: US 2007/0076064 A1
(43) Pub. Date: Apr. 5, 2007

(54) Cap assembly for an ink bottle

(76) Inventors: Yong Wang, Aurora, IL (US); James D. Wilson II, Collinsville, IL (US); Charles C. Mayberry, Harvard, IL (US)

Correspondence Address: MCANDREWS HELD & MALLOY, LTD, 500 WEST MADISON STREET, SUITE 3400, CHICAGO, IL, 60661, US

(21) Appl. No.: 11/240,719

(22) Filed: Sep. 30, 2005

(51) Int. Cl. B41J 2/175

(52) U.S. Cl. 347/86

(57) ABSTRACT

An ink bottle assembly for use with an ink supply system, the ink bottle assembly including a main body and a cap assembly. The main body includes a neck having at least one first ramped feature, such as a ramped ridge. The cap assembly includes a shell secured to the neck and a tip slidably secured to the shell. The shell includes a second ramped feature, wherein the second ramped feature is allowed to pass over the first ramped feature in a first direction, and wherein the second ramped feature abuts against the first ramped feature in a second direction, thereby precluding movement in the second direction.

### BACKGROUND OF THE INVENTION

Embodiments of the present invention generally relate to ink jet printing systems, and more particularly to an improved cap assembly for an ink bottle of an ink jet printing system.

Typically, ink is supplied to ink jet printing systems through the use of disposable ink bottles. An ink bottle may be mounted on an ink reservoir that includes a mating feature that allows ink to pass from the ink bottle into the ink reservoir. Each ink bottle retains a finite amount of ink, typically a pint or liter of ink. As the ink jet printing system is continually used, the ink within the ink bottle is drained. When the ink bottle is fully depleted, a new ink bottle replaces the depleted ink bottle.

When the ink bottle is replaced, excess ink may spill or leak within the ink jet printing system and/or on the operator. For example, when an operator grasps the ink bottle to replace it, the force applied may squeeze the ink bottle, thereby ejecting excess ink from the bottle. Ink spills produce a mess within the ink jet printing system, and possibly outside of the system (e.g., on the surrounding flooring) and on the operator.

Some ink bottles includes a cap assembly including a shell and a tip, in which the tip is selectively opened and closed by sliding it in relation to the tip. Sometimes, however, the tip falls off the shell when the tip is moved into an open position. Additionally, the shell may be lifted off the neck when the cap assembly is opened. Additionally, when the tip is closed in relation to the shell, excess ink that collects between the shell and tip may squirt, or be squeezed, out.

Some manufacturers of ink jet printing systems provide ink bottles or reservoirs that are unique to particular systems. For example, some ink bottles may include a particular keying feature, that allows it to only be used with a particular system, which includes a corresponding mating feature. In some instances, manufacturers of counterfeit products can easily remove the particular component with the keying feature, and secure it to a counterfeit component. For example, if the keying feature is on the cap assembly, a counterfeiter may simply remove the cap assembly from a depleted ink bottle and secure the cap assembly to a counterfeit ink bottle main body.

Thus, a need exists for a more an improved cap assembly that remains secured to the neck, and which prevents fluid from squirting, or otherwise leaking out when the cap assembly is closed. Additionally, a need exists for an ink bottle assembly that precludes it from being used with counterfeit components.

### SUMMARY OF THE INVENTION

Certain embodiments of the present invention provide an ink bottle assembly for use with an ink supply system. The ink bottle assembly includes a main body having a neck, which includes a first ramped feature, or ridge. The ink bottle assembly also includes a cap assembly having a shell secured to the neck and a tip slidably secured to the shell. The shell includes a second ramped ridge, wherein the second ramped ridge is allowed to pass over the first ramped ridge in a first direction, and wherein the second ramped ridge abuts against the first ramped ridge with attempted movement in a second direction, thereby precluding movement in the second direction. The first direction is a securing direction in which the shell is moved to securely engage the neck, and the second direction is an attempted removing direction.

The ink bottle assembly may also include a gasket positioned between a top portion of the neck and the shell. The gasket provides a sealing interface between the neck and the shell.

The tip may also include a first protuberance inwardly-directed toward an outer surface of the shell. The first protuberance acts to assist in securing the tip to the shell and to block fluid leakage from the cap assembly. The shell may also include a second protuberance outwardly-directed toward an inner surface of the tip. The second protuberance also acts to assist in securing the tip to the shell and to block fluid leakage from the cap assembly.

Certain embodiments of the present invention also provide a method of preventing counterfeit ink bottles from being used in an ink supply system. The method includes integrally forming a first ramped feature on an exterior portion of a neck of an ink bottle, integrally forming a second ramped feature on an interior portion of a shell of a cap assembly that threadably secures to the neck of the ink bottle, allowing the first ramped feature to pass over the second ramped feature in a securing direction, and hindering the first ramped feature from passing over the second ramped feature in a direction that is opposite the securing direction. The allowing may include sliding a first ramped surface of the first ramped feature over a second ramped surface of the second ramped feature. The hindering may include abutting a first straight edge of the first ramped surface against a second straight edge of the second ramped surface.

Certain embodiments of the present invention also provide a method of preventing fluid from leaking through a cap assembly of an ink bottle when the cap assembly is closed, wherein the cap assembly includes an inner shell and an outer tip that slides between open and closed positions. The method includes providing at least one protuberance on at least one of the shell and the tip in an area between the shell and the tip, trapping excess fluid within a fluid retention area located within the cap assembly, and blocking the excess fluid from passing through the fluid retention area when the tip is closed relative to the shell with the at least one protuberance. The providing may include providing a first protuberance on an interior surface of the tip and providing a second protuberance on an exterior surface of the shell.

### BRIEF DESCRIPTION OF SEVERAL VIEWS OF THE DRAWINGS

FIG. 1 illustrates an isometric exploded view of an ink bottle according to an embodiment of the present invention.

FIG. 2 illustrates a top isometric view of a shell of a cap assembly according to an embodiment of the present invention.

FIG. 3 illustrates a bottom isometric view of a shell of a cap assembly according to an embodiment of the present invention.

FIG. 4 illustrates a bottom isometric view of a cap assembly according to an embodiment of the present invention.

FIG. 5 illustrates a top isometric view of an ink bottle according to an embodiment of the present invention.

FIG. 6 illustrates a partial cross-sectional view of an ink bottle through line 6-6 shown in FIG. 5.

FIG. 7 illustrates a close-up partial cross-sectional view of a cap assembly secured to a neck of an ink bottle according to an embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

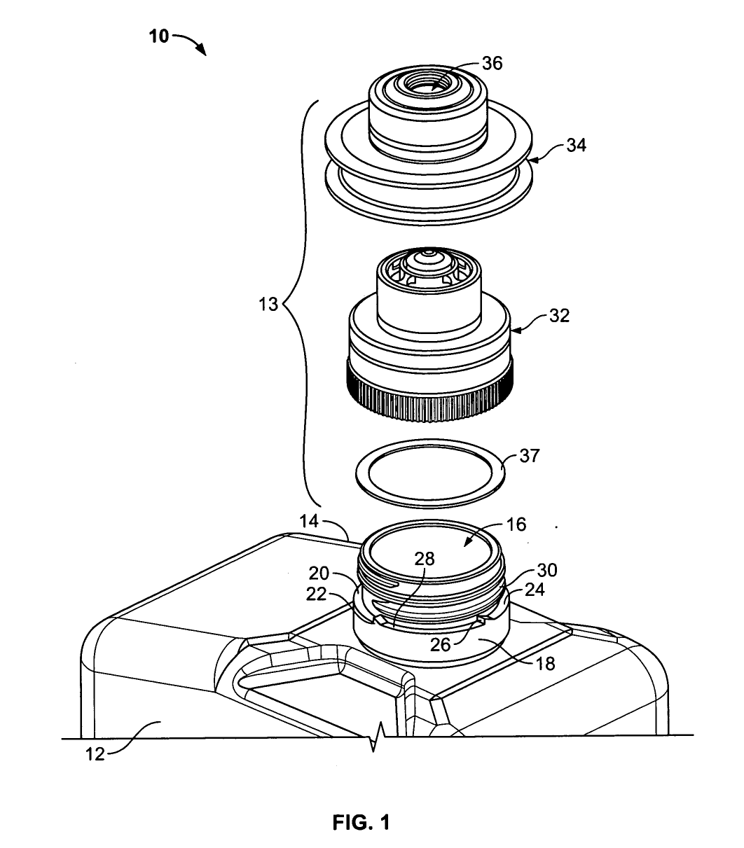

FIG. 1 illustrates an isometric exploded view of an ink bottle 10 according to an embodiment of the present invention. The ink bottle 10 may be used as part of an ink bottle connection system, such as shown and described in U.S. patent application Ser. No. 11/031,236, filed Jan. 6, 2005, which is hereby incorporated by reference in its entirety.

The ink bottle 10 includes a main body 12 having a fluid chamber defined therein and a cap assembly 13, which may include a keying feature(s) that allows mating with only a corresponding ink reservoir. A neck 14 extends upwardly from the main body 12 and has a fluid passage 16 defined therethrough. The fluid passage 16 allows fluid to pass from the fluid chamber into the cap assembly 13.

The neck 14 is integrally formed to the main body 12 at a base 18, which is in turn integrally formed with an upwardly extending tube 20 that defines the fluid passage 16. Upwardly extnending ratchet members, protrusion, protberances, ridges 22, or other such features are spaced along a circumference of the base 18. More or less ridges 22 than those shown may be used. Each ridge 22 includes a ramped surface 24 and an edge 26. The edge 26 may extend perpendicularly from a horizontal ledge 28 of the base 18. Alternatively, the edge 26 may connect to the horizontal ledge 28 of the base 18 through a variety of angles. For example, one end of the edge 26 may connect to the ramped surface 24 at an acute angle while the other end of the edge connects to the ledge 28 at an obtuse angle. As shown in FIG. 1, each ridge 22 is formed in the shape of a triangle or sawtooth. The ridges 22 are configured to secure the cap assembly 13 to the neck 14.

Moreover, the ridges 22 may be configured to preclude the cap assembly 13 from being removed from the neck 14 without scoring, perforating, or otherwise damaging the neck 14 or the cap assembly 13. Thus, the interface between the ridges 22 and reciprocal structures formed within the cap assembly 13 may act as a safeguard against counterfeit cap assemblies or main ink bottle bodies. For example, by scoring or otherwise damaging the neck 14 and/or the cap assembly 13 when the cap assembly 13 is attempted to be removed form the neck, the interface between the ridges 22 and the cap assembly 13 may ensure that the cap assembly 13 may not be used with another ink bottle, and vice versa. That is, if the cap assembly 13 is removed from the neck 14, the cap assembly and/or the neck 14 will be damaged.

Threads 30 outwardly extend from an outer surface of the tube 20. The threads 30 are configured to threadably engage reciprocal structures formed on an interior surface of a shell 32 of the cap assembly 13. More or less threads 30 than those shown in FIG. 1 may be used.

The cap assembly 13 includes the shell 32 and a tip 34. The tip 34 slidably engages the shell 32 and is configured to selectively slide from an open position, in which fluid may exit the cap assembly 13 through a nozzle opening 36, to a closed position. A gasket 37 is positioned within the shell 32 and is configured to sealingly engage around the neck 14.

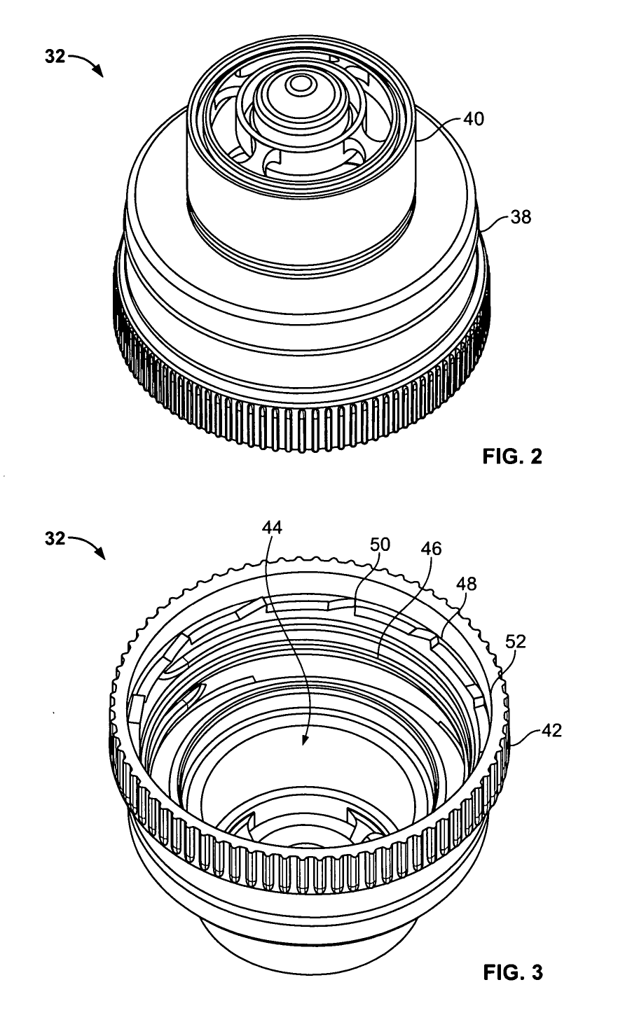

FIG. 2 illustrates a top isometric view of the shell 32. The shell 32 includes a neck-engaging base 38 integrally formed with a fluid nozzle 40, which allows fluid to pass therehthrough. The neck-engaging base 38 is configured to threadbly secure around the neck 14.

FIG. 3 illustrates a bottom isometric view of the shell 32. An outer wall 42 of the shell 32 defines an interior cavity 44. Reciprocal threads 46 extend from an interior surface of the outer wall 42 into the interior cavity 44 and are configured to threadably engage the threads 30 (shown in FIG. 1) of the neck 14 (shown in FIG. 1), in order to secure the shell 32 thereto. Ratcheting protrusion, protuberances, ridges 48, or other such features also outwardly extend from an interior surface of the outer wall 42. Similar to the ridges 22 shown in FIG. 1, the ridges 48 include a ramped surface 50 and an edge 52. The ridges 48 extend outwardly and downwardly so that when the shell 32 is threaded onto the neck 14, the ridges 48 may engage the ridges 22 (shown in FIG. 1) of the neck 14 (shown in FIG. 1).

Referring to FIGS. 1 and 3, when the shell 32 is threaded onto the neck 14, the ramped surfaces 50 of the shell 32 slide over the ramped surface 24 of the neck 14. However, if the shell 32 is threaded in an opposite direction, that is, a removing direction, the edges 52 of the shell 32 abut against the edges 26 of the neck 14, thereby precluding further movement in that direction. If the shell 32 is forced further in that direction, the ridges 52 may score, perforate, or otherwise damage the neck 14, while the ridges 26 may score, perforate, or otherwise damage the interior surface of the outer wall 42 of the shell 32. Thus, embodiments of the present invention may provide a safeguard against using the shell 32 of the cap assembly 13 or the main body 12 of the ink bottle 10 with counterfeit parts.

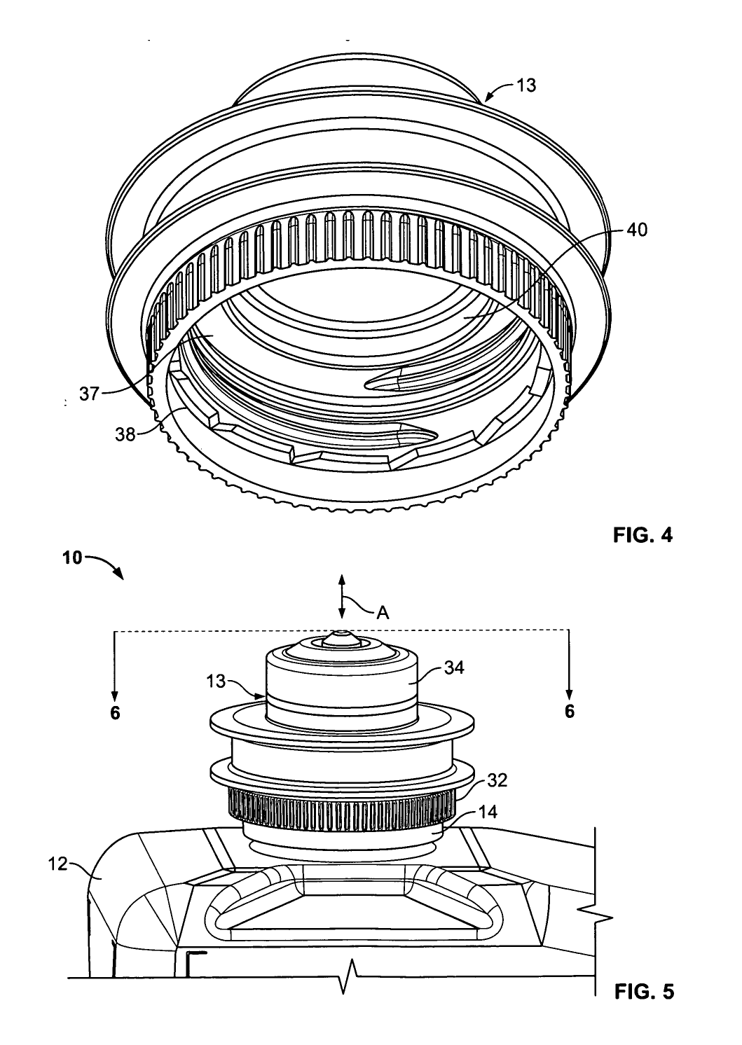

FIG. 4 illustrates a bottom isometric view of the cap assembly 13. The gasket 37 is positioned proximate the union of the neck-engaging base 38 and the fluid nozzle 40. Thus, the gasket 37 may sealingly engage around a top ridge of the neck 14 (shown in FIG. 1) when the cap assembly 13 is threadbly secured to the neck 14. The gasket 37 provides a sealing barrier that provides additional protection against leaks. Alternatively, the gasket 37 may be positioned at various other positions within the cap assembly. Additionally, more than one gasket 37 may be used.

FIG. 5 illustrates a top isometric view of the ink bottle 10 with the cap assembly 13 threadably secured to the neck 14 of the main body 12. The tip 34 may slide relative to the shell 32, which is threadably secured to the neck, between open and closed positions in the direction of arrow A.

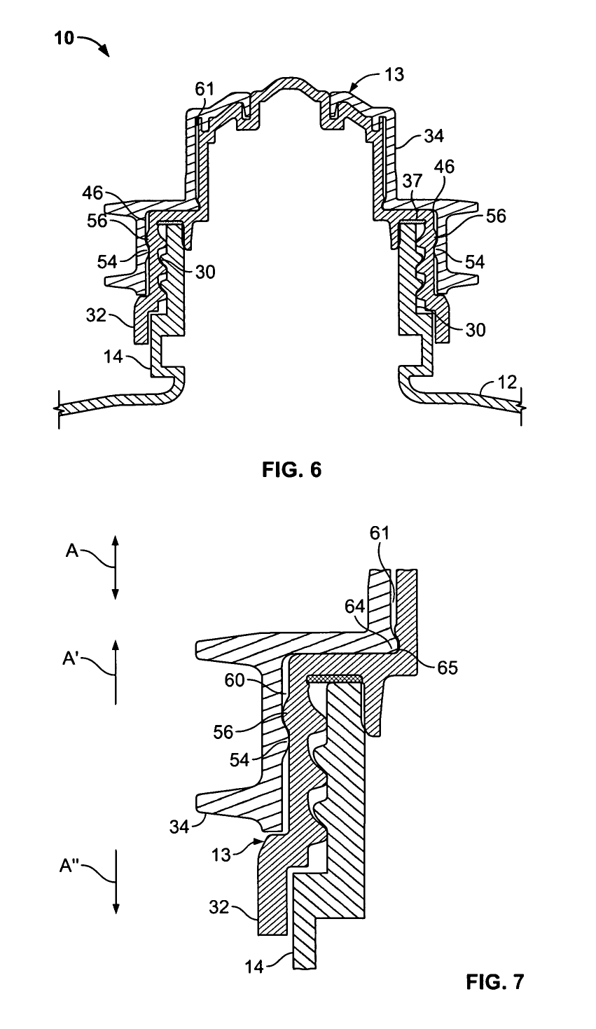

FIG. 6 illustrates a partial cross-sectional view of the ink bottle 10 through line 6-6 shown in FIG. 5. The cap assembly 13 is secured to the neck 14 of the main body 12 by the threads 46 engaging the threads 30. The gasket 37 is positioned at the top of the neck 14. A circumferential snap bead 54, ridge, protrusion, or other such protuberance extends inwardly from an interior wall of the tip 34 toward the shell 32 and cooperates with a snap bead 56 extending outwardly from an outer surface of the shell 32 toward the tip 34. The interaction between the snap beads 54 and 56 assists in maintaining a secure fit between the shell 32 and the tip 34, and also prevents fluid from leaking past.

FIG. 7 illustrates a close-up partial cross-sectional view of the cap assembly 13 secured to the neck 14. As the tip 34 is moved into an open position, the snap bead 54 moves upwardly over the snap bead 56 in the direction of A′. When the tip 34 is moved back into a closed position in the direction of A″, the snap bead 54 moves downwardly over the snap bead 56. The snap beads 54 and 56 engage one another, thereby ensuring that the tip 34 remains slidably secured to the shell 32.

A fluid retention area 60 may be formed above the snap beads 54 and 56, while a fluid retention area 61 may be formed above a snap bead 64. Excess fluid may collect in the fluid retention areas 60 and 61. The snap beads 54 and 56, however, form a barrier that blocks any excess fluid from squirting out of the cap assembly 13 in the direction of arrow A″. In essence, the snap beads 54 and 56 provide a fluid-tight barrier that prevents excess fluid from squeezing out of the cap assembly 13. Optionally, only snap bead 54 or snap bead 56 may be used with the cap assembly 13.

The snap bead 64 is configured to snapably engage a reciprocal depression 65 and forms an air tight connection between the tip 34 and the shell 32. The cap assembly 13 may include additional snap beads or features that are configured to snapably mate and connect with reciprocal structures to robustly secure the shell 32 to the tip 34.

Additionally, as discussed above, the interaction between the ridges 22 of the neck 14 and the ridges 48 (shown, e.g., in FIG. 3) of the shell 32 preclude the cap assembly 13 from being unscrewed from the neck 14.

Embodiments of the present invention provide a more robust cap assembly that remains secured to the neck of an ink bottle. Additionally, embodiments of the present invention provide a cap assembly that minimizes excess fluid from squirting, or being squeezed out when it is being closed. Further, embodiments of the present invention preclude counterfeit parts from being used therewith.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. An ink bottle assembly for use with an ink supply system, the ink bottle assembly comprising:
a main body having a neck, said neck comprising a first ramped ridge; and
a cap assembly having a shell secured to said neck and a tip slidably secured to said shell, said shell comprising a second ramped ridge, wherein said second ramped ridge is allowed to pass over said first ramped ridge in a first direction, and wherein said second ramped ridge abuts against said first ramped ridge with attempted movement in a second direction, thereby precluding movement in the second direction.

2. The ink bottle assembly of claim 1, wherein the first direction is a securing direction in which said shell is moved to securely engage said neck, and wherein the second direction is an attempted removing direction.

3. The ink bottle assembly of claim 1, further comprising a gasket positioned between a top portion of said neck and said shell, said gasket providing a sealing interface between said neck and said shell.

4. The ink bottle assembly of claim 1, wherein said tip further comprises a first protuberance inwardly-directed toward an outer surface of said shell, said first protuberance configured to assist in securing said tip to said shell and to block fluid leakage from said cap assembly.

5. The ink bottle assembly of claim 4, wherein said first protuberance is a snap bead.

6. The ink bottle assembly of claim 4, wherein said shell further comprises a second protuberance outwardly-directed toward an inner surface of said tip, said second protuberance configured to assist in securing said tip to said shell and to block fluid leakage from said cap assembly.

7. The ink bottle assembly of claim 1, wherein the first direction is opposite the second direction.

8. The ink bottle assembly of claim 1, wherein said first ramped ridge extends from an outer circumferential base of said neck toward said cap assembly, and wherein said second ramped ridge extends from an inner circumferential wall of said shell toward said neck.

9. The ink bottle assembly of claim 1, further comprising a plurality of first ramped ridges and a plurality of second ramped ridges.

10. A method of preventing counterfeit ink bottles from being used in an ink supply system, the method comprising:
integrally forming a first ramped feature on an exterior portion of a neck of an ink bottle;
integrally forming a second ramped feature on an interior portion of a shell of a cap assembly that threadably secures to the neck of the ink bottle;
allowing the first ramped feature to pass over the second ramped feature in a securing direction;
hindering the first ramped feature from passing over the second ramped feature in a direction that is opposite the securing direction.

11. The method of claim 10, wherein said allowing comprises sliding a first ramped surface of the first ramped feature over a second ramped surface of the second ramped feature.

12. The method of claim 10, wherein said hindering comprises abutting a first edge of the first ramped surface against a second edge of the second ramped surface.

13. The method of claim 10, further comprising disposing a sealing gasket between the neck and the shell.

14. The method of claim 10, further comprising trapping excess fluid within a fluid retention area within the cap assembly by at least one protuberance.

15. An ink bottle assembly for use with an ink supply system, the ink bottle assembly comprising:
a main body having a neck; and
a cap assembly having a shell secured to said neck and a tip slidably secured to said shell, wherein said tip comprises a first protuberance inwardly-directed toward an outer surface of said shell, said first protuberance configured to assist in securing said tip to said shell and to block fluid leakage from said cap assembly, wherein said first protuberance traps fluid within a fluid retention area between said shell and said tip when said tip is slidably closed relative to said shell.

16. The ink bottle assembly of claim 15, wherein said shell further comprises a second protuberance outwardly-directed toward an inner surface of said tip, said second protuberance configured to assist in securing said tip to said shell and to block fluid leakage from said cap assembly.

17. The ink bottle assembly of claim 16, wherein said first protuberance is a first circumferential snap bead configured to be snapably retained by said shell when said tip is in a closed position, and said second protuberance is a second circumferential snap bead configured to be snapably retained by said tip when said tip is in a closed position.

18. The ink bottle assembly of claim 15, further comprising a gasket positioned between a top portion of said neck and said shell, said gasket providing at least a first sealing interface between said neck and said shell.

19. An ink bottle assembly for use with an ink supply system, the ink bottle assembly comprising:
a main body having a neck; and
a cap assembly having a shell secured to said neck and a tip slidably secured to said shell, wherein said shell comprises a first protuberance outwardly-directed toward an inner surface of said tip, said first protuberance configured to assist in securing said tip to said shell and to block fluid leakage from said cap assembly, wherein said first protuberance traps fluid within a fluid retention area between said shell and said tip when said tip is slidably closed relative to said shell.

20. The ink bottle assembly of claim 19, wherein said tip further comprises a second protuberance inwardly-directed toward an outer surface of said shell, said second protuberance configured to assist in securing said tip to said shell and to block fluid leakage from said cap assembly.

21. A method of preventing fluid from leaking through a cap assembly of an ink bottle when the cap assembly is closed, wherein the cap assembly includes an inner shell and an outer tip that slides between open and closed positions, the method comprising:
providing at least one protuberance on at least one of the shell and the tip in an area between the shell and the tip;
trapping excess fluid within a fluid retention area located within the cap assembly; and
blocking the excess fluid from passing through the fluid retention area when the tip is closed relative to the shell with the at least one protuberance.

22. The method of claim 21, wherein said providing comprises providing a first protuberance on an interior surface of the tip and providing a second protuberance on an exterior surface of the shell.
